(19) United States
(12) Patent Application Publication
(10) Pub. No.: US 2002/0088002 A1
(43) Pub. Date: Jul. 4, 2002

(54) Transmission of camera image to remote display device

(76) Inventors: Peter Rae Shintani, San Diego, CA (US); Matthew S. Chang, San Diego, CA (US); Aditya Krishnan, San Diego, CA (US); Andrew M. Proehl, San Francisco, CA (US); David K. L. Yang, San Jose, CA (US); Fred J. Zustak, Poway, CA (US); Mark Kenneth Eyer, San Diego, CA (US); Nicholas Colsey, Del Mar, CA (US); Brant L. Candelore, Escondido, CA (US); Dayan Ivy Golden, San Diego, CA (US)

Correspondence Address: MILLER PATENT SERVICES, 2500 DOCKERY LANE, RALEIGH, NC, 27606, US

(21) Appl. No.: 09/752,967

(22) Filed: Jan. 2, 2001

(51) Int. Cl. H04N 7/173

(52) U.S. Cl. 725/110; 725/109; 725/131

(57) ABSTRACT

A system for displaying images on a portable device such as a PDA or cellular telephone. A camera captures a still or moving image and sends it to a digital set-top box. The processor of the set-top box reformats the image to an appropriate size and format for display on the display of the PDA or cellular telephone. The image is then transmitted to the portable device using a URL, telephone number, email address or other address.

### FIELD OF THE INVENTION

This invention relates generally to the field of display of images on a display device. More particularly, this invention relates to a method and apparatus for display of images from a camera on a remote device such as a cellular telephone using a television set-top box to convert the image to an appropriate display format.

### BACKGROUND OF THE INVENTION

The Internet has evolved into a powerful mechanism for communication. The Internet is now widely used, not only for communication of Email messages, but also for communication of video information and camera images. One use of the Internet that has recently evolved is that of providing images for remote display of a situation that a user desires to monitor. In one example, day-care centers are now providing video images to parents throughout the day via the Internet. These images are accessible by the parents by simply addressing a particular web site. Using this technology, a parent can check on the condition of the day-care center, and the behavior of the daycare center personnel and well being of their children throughout the day by simply downloading the latest image or series of images.

Portable communication devices are also now more frequently providing a user with access to the Internet. Unfortunately, such devices vary significantly in their display capability, and there is currently no easy way to provide the user of such devices with access to images from the web.

With the advent of modern digital set-top boxes used within the home or office to tune satellite and cable-based television systems, a great deal of computing power is available to the consumer. Moreover, such digital set-top boxes provide the user with a great deal of communication bandwidth and access to the Internet.

### SUMMARY OF THE INVENTION

The present invention relates generally to a method and apparatus for display of images on a remote device. Objects, advantages and features of the invention will become apparent to those skilled in the art upon consideration of the following detailed description of the invention.

Certain embodiments of the present invention provide a system for displaying images on a portable device such as a PDA or cellular telephone. A camera captures a still or moving image and sends it to a digital set-top box. The processor of the set-top box reformats the image to an appropriate size and format for display on the display of the PDA or cellular telephone. The image is then transmitted to the portable device using a URL, telephone number, email address or other address.

In one embodiment consistent with the invention, a method of displaying an image includes: at a television set-top box, receiving an image from a video camera; at the television set-top box, formatting the image for display of the image on a selected display to produce a formatted image; and transmitting the formatted image from the television set-top box to an address for the selected display.

A set-top box consistent with embodiments of the present invention includes an interface for receiving an image from a video camera. A programmed processor is operatively coupled to the interface that formats the image for display of the image on a selected display to produce a formatted image. A transmitting device such as a modem transmits the formatted image from the television set-top box to an address for the selected display.

The above summaries are intended to illustrate exemplary embodiments of the invention, which will be best understood in conjunction with the detailed description to follow, and are not intended to limit the scope of the appended claims.

### BRIEF DESCRIPTION OF THE DRAWINGS

The features of the invention believed to be novel are set forth with particularity in the appended claims. The invention itself however, both as to organization and method of operation, together with objects and advantages thereof, may be best understood by reference to the following detailed description of the invention, which describes certain exemplary embodiments of the invention, taken in conjunction with the accompanying drawings in which:

FIG. 1 is a system block diagram of a system using a set-top box.

FIG. 2 is a functional block diagram of a digital set-top box suitable for use with the present invention.

FIG. 3 is a flow chart of a first embodiment of the present invention.

FIG. 4 is a flow chart of a second embodiment of the present invention.

FIG. 5 is a flow chart of a setup technique for use in an embodiment of the present invention.

### DETAILED DESCRIPTION OF THE INVENTION

While this invention is susceptible of embodiment in many different forms, there is shown in the drawings and will herein be described in detail specific embodiments, with the understanding that the present disclosure is to be considered as an example of the principles of the invention and not intended to limit the invention to the specific embodiments shown and described. In the description below, like reference numerals are used to describe the same, similar or corresponding parts in the several views of the drawings.

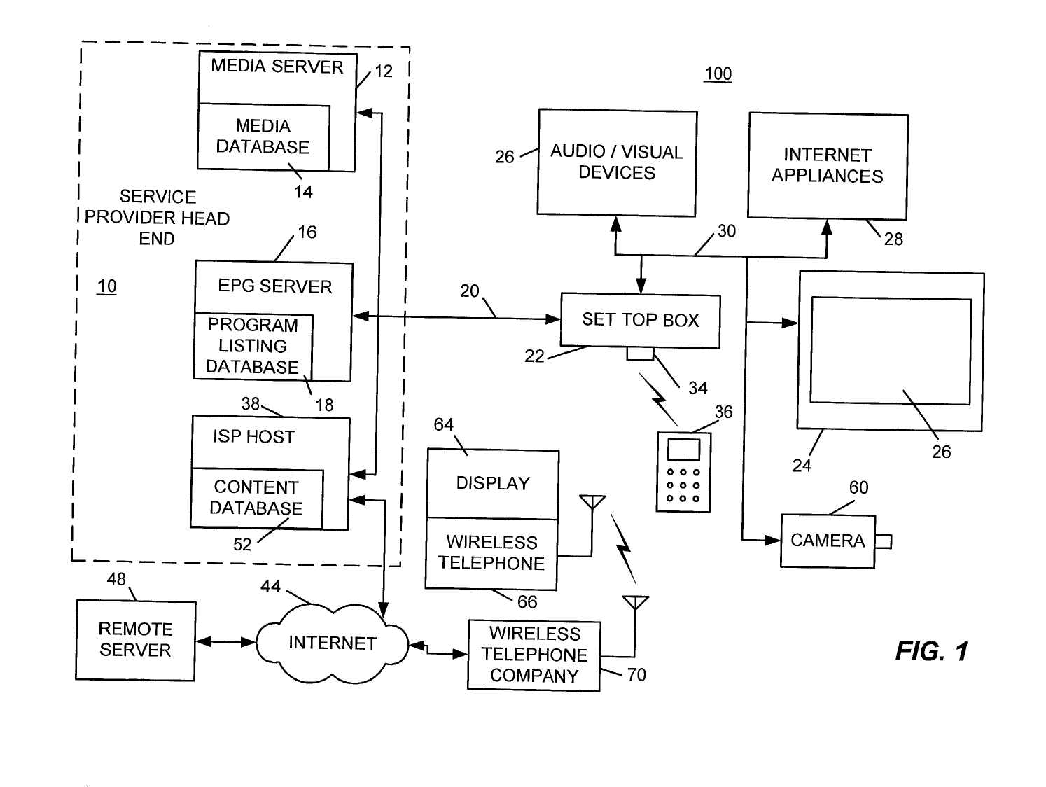

Referring to FIG. 1, a block diagram for an exemplary interactive cable or satellite television (TV) system 100 is shown. The system 100 includes, at a head end of the service provider 10, a media server 12 for providing, on demand, movies and other programming obtained from a media database 14. The media server 12 might also provide additional content such as interviews with the actors, games, advertisements, available merchandise, associated Web pages, interactive games and other related content. The system 100 also includes an electronic programming guide (EPG) server 16 and a program listing database 18 for generating an EPG. Set-top box 22 can generally provide for bidirectional communication over a transmission medium 20 in the case of a cable STB 22. In other embodiments, bidirectional communication can be effected using asymmetrical communication techniques possibly using dual communication media—one for the uplink and one for the downlink. In any event, the STB 22 can have its own Universal Resource Locator (URL) or IP address or other unique identifier assigned thereto to provide for addressability by the head end and users of the Internet.

The media server 12 and EPG server 16 are operatively coupled by transmission medium 20 to a set-top box (STB) 22. The transmission medium 20 may include, for example, a conventional coaxial cable network, a fiber optic cable network, telephone system, twisted pair, a satellite communication system, a radio frequency (RF) system, a microwave system, other wireless systems, a combination of wired and wireless systems or any of a variety of known electronic transmission mediums. In the case of a cable television network, transmission medium 20 is commonly realized at the subscriber's premises as a coaxial cable that is connected to a suitable cable connector at the rear panel of the STB 22. In the case of a Direct Satellite System (DSS), the STB 22 is often referred to as an Integrated Receiver Decoder (IRD). In the case of a DSS system, the transmission medium is a satellite transmission at an appropriate microwave band. Such transmissions are typically received by a satellite dish antenna with an integral Low Noise Block (LNB) that serves as a down-converter to convert the signal to a lower frequency for processing by the STB 22.

The exemplary system 100 further includes a TV 24, such as a digital television, having a display 26 for displaying programming, an EPG, etc. The STB 22 may be coupled to the TV 24 and various other audiovisual devices 26 (such as audio systems, Personal Video Recorders (PVRs), Video Tape Recorders (VTRs), Video Cassette Recorders (VCRs) and the like), storage devices (e.g., hard disc drives) and Internet Appliances 28 (such as email devices, home appliances, storage devices, network devices, and other Internet-Enabled Appliances) by an appropriate interface 30, which can be any suitable analog or digital interface. In one embodiment, interface 30 conforms to an interface standard such as the Institute of Electrical and Electronics Engineers (IEEE) 1394 standard, but could also be wholly or partially supported by a DVI interface (Digital Visual Interface-Digital Display Working Group, www.ddwg.org) or other suitable interface.

The STB 22 may include a central processing unit (CPU) such as a microprocessor and memory such as Random Access Memory (RAM), Read Only Memory (ROM), flash memory, mass storage such as a hard disc drive, floppy disc drive, optical disc drive or may accommodate other electronic storage media, etc. Such memory and storage media is suitable for storing data as well as instructions for programmed processes for execution on the CPU, as will be discussed later. Information and programs stored on the electronic storage media or memory may also be transported over any suitable transmission medium such as that illustrated as 20. STB 22 may include circuitry suitable for audio decoding and processing, the decoding of video data compressed in accordance with a compression standard such as the Motion Pictures Experts Group (MPEG) standard and other processing to form a controller or central hub. Alternatively, components of the STB 22 may be incorporated into the TV 24 itself, thus eliminating the STB 22. Further, a computer having a tuner device and modem may be equivalently substituted for the TV 24 and STB 22.

By way of example, the STB 22 may be coupled to devices such as a personal computer, video cassette recorder, camcorder, digital camera, personal digital assistant and other audio/visual or Internet related devices. In addition, a data transport architecture, such as that set forth by an industry group which includes Sony Corporation and known as the Home Audio-Video Interoperability (HAVi) architecture may be utilized to enable interoperability among devices on a network regardless of the manufacturer of the device. This forms a home network system wherein electronic devices and Internet appliances are compatible with each other. The STB 22 runs an operating system suitable for a home network system such as Sony Corporation's Aperios™ real time operating system. Other operating systems could also be used.

The STB 22 includes an infrared (IR) receiver 34 for receiving IR signals from an input device such as remote control 36. Alternatively, it is noted that many other control communication methods may be utilized besides IR, such as wired or wireless radio frequency, etc. In addition, it can be readily appreciated that the input device 36 may be any device suitable for controlling the STB 22 such as a remote control, personal digital assistant, laptop computer, keyboard or computer mouse. In addition, an input device in the form of a control panel located on the TV 24 or the STB 22 can be provided.

The STB 22 may also be coupled to an independent service provider (ISP) host 38 by a suitable connection including dial-up connections, DSL (Digital Subscriber Line) or the same transmission medium 20 described above (e.g., using a cable modem) to, thus, provide access to services and content from the ISP and the Internet. The ISP host 38 provides various content to the user that is obtained from a content database 42. STB 22 may also be used as an Internet access device to obtain information and content from remote servers such as remote server 48 via the Internet 44 using host 38 operating as an Internet portal, for example. In certain satellite STB environments, the data can be downloaded at very high speed from a satellite link, with asymmetrical upload speed from the set-top box provided via a dial-up or DSL connection.

While the arrangement illustrated in FIG. 1 shows a plurality of servers and databases depicted as independent devices, any one or more of the servers can operate as server software residing on a single computer. Moreover, although not explicitly illustrated, the servers may operate in a coordinated manner under centralized or distributed control to provide multiple services as a Multiple Service Operator (MSO) in a known manner. Additionally, the services provided by the servers shown in FIG. 1 may actually reside in other locations, but from the perspective of the user of STB 22, the service provider 10 serves as a portal to the services shown. Those skilled in the art will appreciate that the illustration of FIG. 1 represents a simplified depiction of a cable system configuration shown simply as service provider 10. The actual configuration of the service provider's equipment is more likely to follow a configuration defined by the CableLabs OpenCable™ specification. The simplified illustration shown is intended to simplify the discussion of the service provider 10's operation without unnecessarily burdening the discussion with architectural details that will be evident to those skilled in the art. Those details can be found in the publicly available CableLabs OpenCable™ specification or in the text “OpenCable Architecture (Fundamentals)” by Michael Adams, Cisco Press, November 1999.

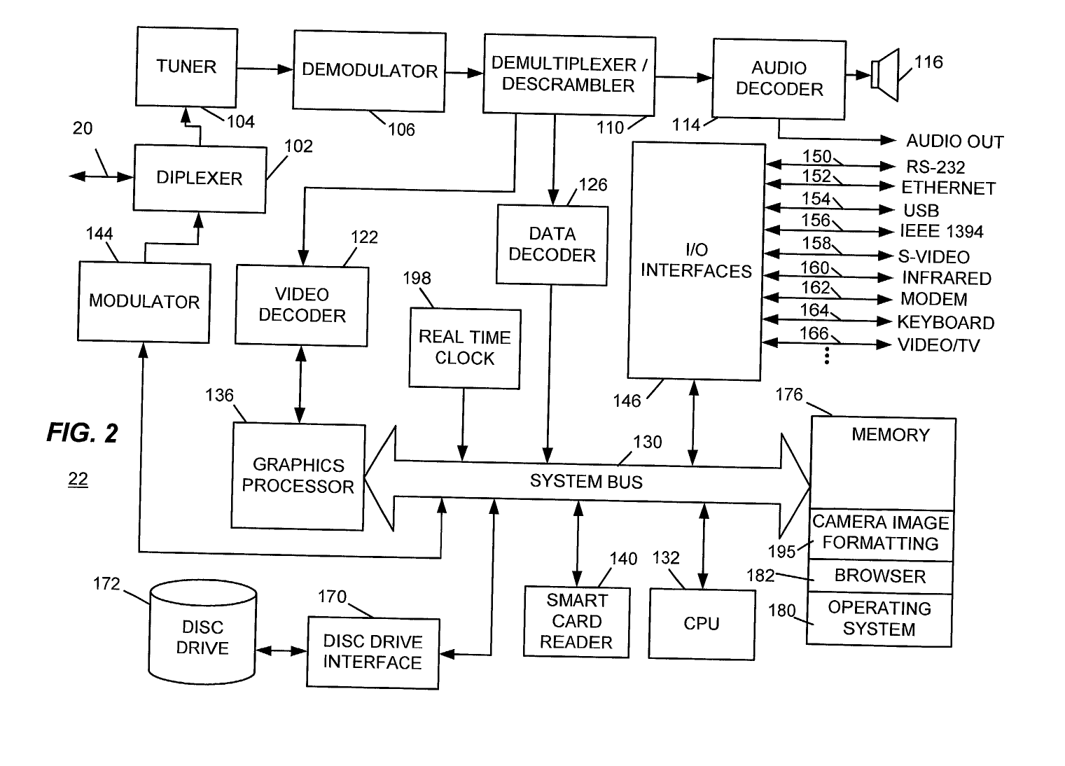

Referring now to FIG. 2, a typical system configuration for a digital set-top box 22 is illustrated. In this exemplary set-top box, the transmission medium 20, such as a coaxial cable, is coupled by a suitable interface through a diplexer 102 to a tuner 104. Tuner 104 may, for example, include a broadcast in-band tuner for receiving content, an out-of-band (OOB) tuner for receiving data transmissions. A return path through diplexer 102 provides an OOB return path for outbound data (destined for example for the head end). A separate tuner (not shown) may be provided to receive conventional RF broadcast television channels. Modulated information formatted, for example, as MPEG-2 information is then demodulated at a demodulator 106. The demodulated information at the output of demodulator 106 is provided to a demultiplexer and descrambler circuit 110 where the information is separated into discrete channels of programming. The programming is divided into packets, each packet bearing an identifier called a Packet ID (PID) that identifies the packet as containing a particular type of data (e.g., audio, video, data). The demodulator and descrambler circuit 110 also decrypts encrypted information in accordance with a decryption algorithm to prevent unauthorized access to programming content, for example.

Audio packets from the demultiplexer 110 (those identified with an audio PID) are decrypted and forwarded to an audio decoder 114 where they may be converted to analog audio to drive a speaker system (e.g., stereo or home theater multiple channel audio systems) or other audio system 116 (e.g., stereo or home theater multiple channel amplifier and speaker systems) or may simply provide decoded audio out at 118. Video packets from the demultiplexer 110 (those identified with a video PID) are decrypted and forwarded to a video decoder 122. In a similar manner, data packets from the demultiplexer 110 (those identified with a data PID) are decrypted and forwarded to a data decoder 126.

Decoded data packets from data decoder 126 are sent to the set-top box's computer system via the system bus 130. A central processing unit (CPU) 132 can thus access the decoded data from data decoder 126 via the system bus 130. Video data decoded by video decoder 122 is passed to a graphics processor 136, which is a computer optimized to processes graphics information rapidly. Graphics processor 136 is particularly useful in processing graphics intensive data associated with Internet browsing, gaming and multimedia applications such as those associated with MHEG (Multimedia and Hypermedia information coding Experts Group) set-top box applications. It should be noted, however, that the function of graphics processor 136 may be unnecessary in some set-top box designs having lower capabilities, and the function of the graphics processor 136 may be handled by the CPU 132 in some applications where the decoded video is passed directly from the demultiplexer 110 to a video encoder. Graphics processor 136 is also coupled to the system bus 130 and operates under the control of CPU 132.

Many set-top boxes such as STB 22 may incorporate a smart card reader 140 for communicating with a so called “smart card,” often serving as a Conditional Access Module (CAM). The CAM typically includes a central processor unit (CPU) of its own along with associated RAM and ROM memory. Smart card reader 140 is used to couple the system bus of STB 22 to the smart card serving as a CAM (not shown). Such smart card based CAMs are conventionally utilized for authentication of the user and authentication of transactions carried out by the user as well as authorization of services and storage of authorized cryptography keys. For example, the CAM can be used to provide the key for decoding incoming cryptographic data for content that the CAM determines the user is authorized to receive.

STB 22 can operate in a bidirectional communication mode so that data and other information can be transmitted not only from the system's head end to the end user, or from a service provider to the end user of the STB 22, but also, from the end user upstream using an out-of-band channel. In one embodiment, such data passes through the system bus 130 to a modulator 144 through the diplexer 102 and out through the transmission medium 20. This capability is used to provide a mechanism for the STB 22 and/or its user to send information to the head end (e.g., service requests or changes, registration information, etc.) as well as to provide fast outbound communication with the Internet or other services provided at the head end to the end user.

Set-top box 22 may include any of a plurality of I/O (Input/Output) interfaces represented by I/O interfaces 146 that permit interconnection of I/O devices to the set-top box 22. By way of example, and not limitation, a serial RS-232 port 150 can be provided to enable interconnection to any suitable serial device supported by the STB 22's internal software. Similarly, communication with appropriately compatible devices can be provided via an Ethernet port 152, a USB (Universal Serial Bus) port 154, an IEEE 1394 (so-called firewire™ or i-link™) or IEEE 1394 wide port 156, S-video port 158 or infrared port 160. Such interfaces can be utilized to interconnect the STB 22 with any of a variety of accessory devices such as storage devices, audio/visual devices 26, gaming devices (not shown), Internet Appliances 28, etc.

I/O interfaces 146 can include a modem (be it dial-up, cable, DSL or other technology modem) having a modem port 162 to facilitate high speed or alternative access to the Internet or other data communication functions. In one preferred embodiment, modem port 162 is that of a DOCSIS (Data Over Cable System Interface Specification) cable modem to facilitate high speed network access over a cable system, and port 162 is appropriately coupled to the transmission medium 20 embodied as a coaxial cable. Thus, the STB 22 can carry out bidirectional communication via the DOCSIS cable modem with the STB 22 being identified by a unique IP address. The DOCSIS specification is publically available.

A PS/2 or other keyboard/mouse/joystick interface such as 164 can be provided to permit ease of data entry to the STB 22. Such inputs provide the user with the ability to easily enter data and/or navigate using pointing devices. Pointing devices such as a mouse or joystick may be used in gaming applications.

Of course, STB 22 also may incorporate basic video outputs 166 that can be used for direct connection to a television set such as 24 instead of (or in addition to) an IEEE 1394 connection such as that illustrated as 30. In one embodiment, Video output 166 can provide composite video formatted as NTSC (National Television System Committee) video. In some embodiments, the video output 166 can be provided by a direct connection to the graphics processor 136 or the demultiplexer/descrambler 110 rather than passing through the system bus 130 as illustrated in the exemplary block diagram. S-Video signals from output 158 can be similarly provided without passing through the system bus 130 if desired in other embodiments.

The infrared port 160 can be embodied as an infrared receiver 34 as illustrated in FIG. 1, to receive commands from an infrared remote control 36, infrared keyboard or other infrared control device. Although not explicitly shown, front panel controls may be used in some embodiments to directly control the operation of the STB 22 through a front panel control interface as one of interfaces 146. Selected interfaces such as those described above and others can be provided in STB 22 in various combinations as required or desired.

STB 22 will more commonly, as time goes on, include a disc drive interface 170 and disc drive mass storage 172 for user storage of content and data as well as providing storage of programs operating on CPU 132. STB 22 may also include floppy disc drives, CD ROM drives, CD R/W drives, DVD drives, etc. CPU 132, in order to operate as a computer, is coupled through the system bus 130 (or through a multiple bus architecture) to memory 176. Memory 178 may include a combination any suitable memory technology including Random Access Memory (RAM), Read Only Memory (ROM), Flash memory, Electrically Erasable Programmable Read Only Memory (EEPROM), etc.

While the above exemplary system including STB 22 is illustrative of the basic components of a digital set-top box suitable for use with the present invention, the architecture shown should not be considered limiting since many variations of the hardware configuration are possible without departing from the present invention. The present invention could, for example, also be implemented in more advanced architectures such as that disclosed in U.S. patent application Ser. No. 09/473,625, filed Dec. 29, 1999, Docket No. SONY-50N3508 entitled “Improved Internet Set-Top Box Having and In-Band Tuner and Cable Modem” to Jun Maruo and Atsushi Kagami. This application describes a set-top box using a multiple bus architecture with a high level of encryption between components for added security. This application is hereby incorporated by reference as though disclosed fully herein.

In general, during operation of the STB 22, an appropriate operating system180 such as, for example, Sony Corporation's Aperios™ real time operating system is loaded into, or is permanently stored in, active memory along with the appropriate drivers for communication with the various interfaces. In other embodiments, other operating systems such as Microsoft Corporation's Windows CE™ could be used without departing from the present invention. Along with the operating system and associated drivers, the STB 22 usually operates using browser software 182 in active memory or may permanently reside in ROM, EEPROM or Flash memory, for example. The browser software 182 typically operates as the mechanism for viewing not only web pages on the Internet, but also serves as the mechanism for viewing an Electronic Program Guide (EPG) formatted as an HTML document. The browser 182 can also provide the mechanism for viewing normal programming (wherein normal programming is viewed as an HTML video window—often occupying the entire area of screen 26).

STB software architectures vary depending upon the operating system. However, in general, all such architectures generally include, at the lowest layer, various hardware interface layers. Next is an operating system layer as previously described. The software architectures of modern STB have generally evolved to include a next layer referred to as “middleware.” Such middleware permits applications to run on multiple platforms with little regard for the actual operating system in place. Middleware standards are still evolving at this writing, but are commonly based upon Javascript and HTML (hypertext Markup Language) virtual machines. At the top layer is the application layer where user applications and the like reside (e.g., browsing, email, EPG, Video On Demand (VOD), rich multimedia applications, pay per view, etc.). The current invention can be utilized with any suitable set-top box software and hardware architecture.

Referring back to FIG. 1, the present invention contemplates attachment of a camera 60 to the set-top box 22, for example via an IEEE 1394 interface such as 30. Camera 60 may be either a video or still camera capturing images in either color or black and white. The camera may output either analog or digital video, but in the preferred embodiment, the camera outputs video in a digital format such as JPEG or MPEG format for still or moving images respectively.

Referring back to FIG. 2 in conjunction with FIG. 1, the images are received by the set-top box 22 which includes software 195 that formats the image received from the camera 60 into a selected format that can be displayed or a display 64 of a remote device such as a personal digital assistant (PDA) or wireless telephone 66 (e.g., a cellular-type telephone including all analog and digital formats of such telephones including CDMA, TDMA, PCS and analog). A real time clock 198 may be provided to maintain accurate time for used by the STB 22 in carrying our various programmed operations.

Present devices such as wireless telephones that are capable of communication with the Internet (i.e., a portable wireless electronic Internet-enabled appliance), typically incorporate small displays with comparatively low resolution. Accordingly, it is not generally possible to display full resolution images thereon in the same manner that images can be displayed on, for example, a high resolution computer display. Such portable device displays such as display 66 might currently only provide a resolution of perhaps 150×300 pixels. Of course, this resolution will likely increase substantially over time.

In accordance with one embodiment of the invention, the STB 22, which has its own URL and can be constantly in communication with the service provider 10, can be addressed by a remote user of, for example, a cellular telephone whenever an image is desired. Camera 60 (or multiple cameras) can be set up to monitor a room in a home or otherwise present an image for viewing by the user. The user of the remote device 66 can simply send a command by selecting a menu selection from the wireless device 66 to an operator such as a wireless telephone company 70 (FIG. 1) that then relays the request to the Internet 44. Since the STB 22 has its own URL, the Internet message is routed appropriately to the service provider 10 through ISP host 38 and out to the STB 22. The STB 22 then captures a still or moving video image from camera 60, formats it appropriately for the wireless device 66 and transmits it to device 66 using the reverse path back through operator 70.

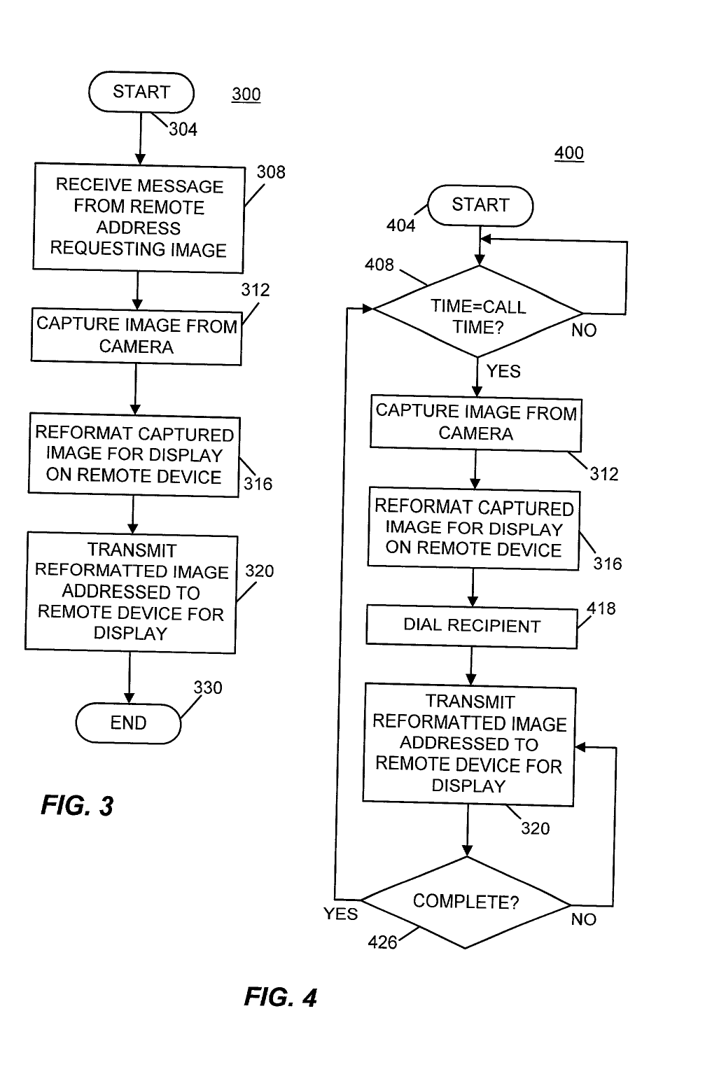

This process is outlined in the process 300 of FIG. 3 starting at 304. At 308, a message is received from the remote device's address requesting that an image be downloaded. At 312, an image is captured by camera 60. This image can be either a still image (e.g., JPEG), a full motion (e.g., MPEG) or a partial motion image in color or black and white. At 316, the image is reformatted in a manner suitable for display on the target device's display 64. In one embodiment, the format can be determined by reference to a database stored in disc drive 172 of the STB 22 that associates a target address (e.g., email, phone number or URL) with all of the appropriate parameters needed by processor 132 operating under program control to carry out the required reformatting. The reformatting can be accomplished, for example in the case of a JPEG or an MPEG image, by simply converting the frame size for the image to an appropriate frame size for the target device's display in a manner similar to resizing such an image for display on a higher resolution display. In addition, the reformatting can include conversion from color to a grey scale image (black and white image) if the display cannot display color images. The reformatted image is then transmitted to the target device 66 for display on display 64 at 320. This can entail either directing the image to a URL, an email address or a telephone number equivalently, as will be appreciated by those skilled in the art. The process ends at 330.

In the process 300 described above, the image is “pulled” by the target device as desired by the user, either manually or under program control. FIG. 4 describes a process 400 in which the image is pushed to the target device under control of a timer or real time clock such as clock 198 of FIG. 2. The process starts at 404 after which the programmed processor 132 monitors real time clock 198 to determine if the current time equals a time designated to call the remote device 66 at 408 under program control. When the appropriate time is reached, an image is captured as in process 300 at 312 and reformatted at 316. At 416, the remote device 66 is called or otherwise addresses (e.g., using an email address or URL) and the reformatted image is transmitted at 320 until the transmission is complete at 426 at which point control returns to 408 to await the next valid transmission time.

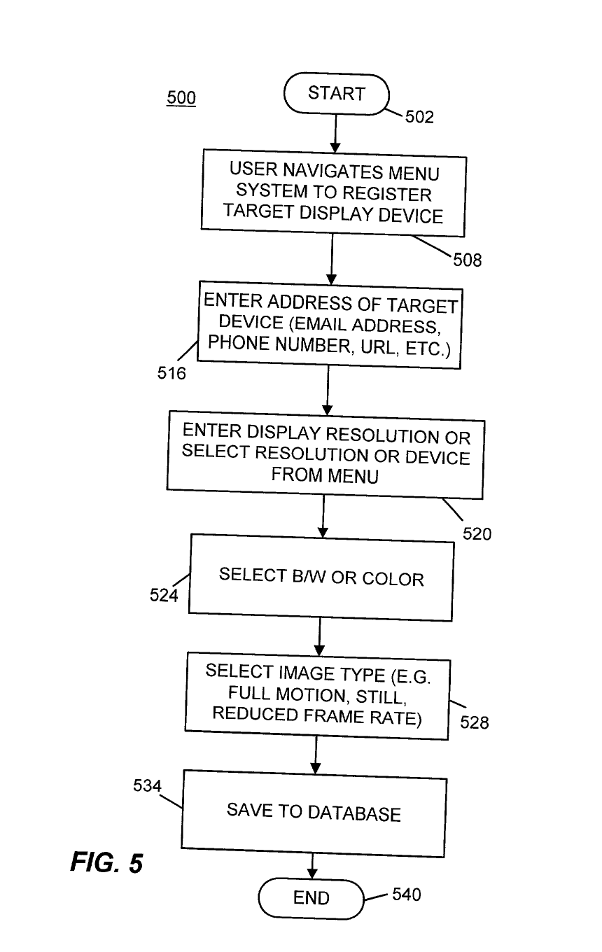

Due to the varying parameters that are required to appropriately format an image for transmission at 316, the STB 22 should be apprised of an appropriate format for the image. This can be accomplished in any suitable manner as will occur to those skilled in the art. One such process is illustrated as process 500 of FIG. 5. Process 500 starts at 502 after which an on screen menu is displayed on display26 and navigated by the user (e.g., using remote controller 36) to register the target remote device with STB 22 at 508. At 516, the user enters an address for the target device with which to associate the parameters being registered. Various parameters may be registered in any suitable order without limitation such as the display resolution at 520, color or black and white at 524, and image type (still, full motion, reduced frame rate, etc.) at 528. In an alternative embodiment, the device may simply be selected from a menu of supported devices to automatically load the appropriate parameters. At 534 the parameters are saved to a database and associated with the remote device address therein and the process ends at 540.

Those skilled in the art will recognize that the present invention has been described in terms of exemplary embodiments based upon use of a programmed processor. However, the invention should not be so limited, since the present invention could be implemented using hardware component equivalents such as special purpose hardware and/or dedicated processors which are equivalents to the invention as described and claimed. Similarly, general purpose computers, microprocessor based computers, micro-controllers, optical computers, analog computers, dedicated processors and/or dedicated hard wired logic may be used to construct alternative equivalent embodiments of the present invention.

Those skilled in the art will appreciate that the program steps used to implement the embodiments described above can be implemented using disc storage as well as other forms of storage including Read Only Memory (ROM) devices, Random Access Memory (RAM) devices; optical storage elements, magnetic storage elements, magneto-optical storage elements, flash memory, core memory and/or other equivalent storage technologies without departing from the present invention. Such alternative storage devices should be considered equivalents.

The present invention is preferably implemented using a programmed processor executing programming instructions that are broadly described above in flow chart form and which can be stored as instructions on an electronic storage medium. However, those skilled in the art will appreciate that the processes described above can be implemented in any number of variations and in many suitable programming languages without departing from the present invention. For example, the order of certain operations carried out can often be varied, and additional operations can be added without departing from the invention. Error trapping can be added and/or enhanced and variations can be made in user interface and information presentation without departing from the present invention. Such variations are contemplated and considered equivalent.

While the invention has been described in conjunction with specific embodiments, it is evident that many alternatives, modifications, permutations and variations will become apparent to those skilled in the art in light of the foregoing description. Accordingly, it is intended that the present invention embrace all such alternatives, modifications and variations as fall within the scope of the appended claims.

What is claimed is:

1. A method of displaying an image, comprising:
at a television set-top box, receiving an image from a video camera;
at the television set-top box, formatting the image for display of the image on a selected display to produce a formatted image; and
transmitting the formatted image from the television set-top box to an address for the selected display.

2. The method according to claim 1, wherein the selected display comprises a display of a portable wireless electronic Internet-enabled appliance.

3. The method according to claim 2, wherein the portable wireless electronic Internet-enabled appliance comprises a wireless telephone.

4. The method according to claim 2, wherein the portable wireless electronic Internet-enabled appliance comprises a personal digital assistant.

5. The method according to claim 1, wherein the address comprises one of a telephone number, an email address and a universal resource locator for a portable wireless electronic Internet-enabled appliance.

6. The method according to claim 1, wherein the image comprises one of a still image, a full motion image and a reduced frame rate image.

7. The method according to claim 1, wherein the image comprises one of a color image and a black and white image.

8. The method according to claim 1, wherein the image comprises one of a JPEG still image, and an MPEG full motion image.

9. The method according to claim 1, wherein the formatting comprises reformatting a JPEG image for a reduced frame size.

10. The method according to claim 1, wherein the formatting comprises reformatting a MPEG image for a reduced frame size.

11. The method according to claim 1, further comprising retrieving display parameters from a database indexed from the address, and wherein the formatting is carried out in accordance with the display parameters.

12. A method of displaying an image, comprising:
at a television set-top box, receiving a color JPEG image from a video camera;
retrieving display parameters from a database indexed from a target address;
at the television set-top box, formatting the image for display of the image on a selected display by reformatting the JPEG image for a reduced frame size to produce a formatted image in accordance with the display parameters, wherein the selected display comprises a display of a portable wireless electronic Internet-enabled appliance
transmitting the formatted image from the television set-top box to an address for the selected display, wherein the address comprises one of a telephone number, an email address and a universal resource locator for a portable wireless electronic Internet-enabled appliance.

13. The method according to claim 12, wherein the portable wireless electronic Internet-enabled appliance comprises a wireless telephone.

14. The method according to claim 12, wherein the portable wireless electronic Internet-enabled appliance comprises a personal digital assistant.

15. A set-top box, comprising:
an interface for receiving an image from a video camera;
a programmed processor operatively coupled to the interface that formats the image for display of the image on a selected display to produce a formatted image; and
transmitting means for transmitting the formatted image from the television set-top box to an address for the selected display.

16. The apparatus according to claim 15, wherein the selected display comprises a display of a portable wireless electronic Internet-enabled appliance.

17. The apparatus according to claim 16, wherein the portable wireless electronic Internet-enabled appliance comprises a wireless telephone.

18. The apparatus according to claim 16, wherein the portable wireless electronic Internet-enabled appliance comprises a personal digital assistant.

19. The apparatus according to claim 15, wherein the address comprises one of a telephone number, an email address and a universal resource locator for a portable wireless electronic Internet-enabled appliance.

20. The apparatus according to claim 15, wherein the image comprises one of a still image, a full motion image and a reduced frame rate image.

21. The apparatus according to claim 15, wherein the image comprises one of a color image and a black and white image.

22. The apparatus according to claim 15, wherein the image comprises one of a JPEG still image, and an MPEG full motion image.

23. The apparatus according to claim 15, wherein the programmed processor carries out the formatting by reformatting a JPEG image for a reduced frame size.

24. The apparatus according to claim 15, wherein the programmed processor carries out the formatting by reformatting an MPEG image for a reduced frame size.

25. The apparatus according to claim 15, wherein the transmitting means comprises a modem.

26. The apparatus according to claim 25, wherein the modem comprises a cable modem.

26. The apparatus according to claim 15, further comprising a real time clock coupled to the programmed processor, and wherein the interface receives an image for transmission whenever the real time clock reaches a designated time.

27. The apparatus according to claim 15, further comprising a database associating display parameters with the address, and wherein the formatting is carried out in accordance with the display parameters.
